(19) United States
(12) Patent Application Publication
(10) Pub. No.: US 2021/0024305 A1
(43) Pub. Date: Jan. 28, 2021

(54) SHEET LOADER AND IMAGE FORMING APPARATUS INCORPORATING THE SHEET LOADER

(71) Applicant: Mizuna TANAKA, Tokyo (JP)

(72) Inventor: Mizuna TANAKA, Tokyo (JP)

(73) Assignee: Ricoh Company, Ltd., Tokyo (JP)

(21) Appl. No.: 16/890,161

(22) Filed: Jun. 2, 2020

(30) Foreign Application Priority Data
Jul. 25, 2019 (JP) 2019-136662

(51) Int. Cl. B65H 1/04; B65H 1/26; B65H 9/06; B65H 9/10; G03G 15/00

(52) U.S. Cl. CPC B65H 1/04; B65H 1/266; B65H 9/06; B65H 9/101; G03G 15/6502; B65H 2405/11425; G03G 2215/00383; B65H 2404/725; B65H 2401/15; B65H 2402/10; B65H 2404/53; G03G 2215/0021; B65H 2404/742

(57) ABSTRACT

A sheet loader includes a housing and a fence. The housing has a bottom face. The fence is movable in a fence moving direction and configured to regulate a position of an end face of the sheet to be loaded in the housing. The fence includes a sliding face and a bend. The sliding face is configured to slide on the bottom face of the housing as the fence moves. The bend is disposed at an end of the sliding face in the fence moving direction and bent in a direction away from the bottom face of the housing.

### CROSS-REFERENCE TO RELATED APPLICATION

This patent application is based on and claims priority pursuant to 35 U.S.C. § 119(a) to Japanese Patent Application No. 2019-136662, filed on Jul. 25, 2019, in the Japan Patent Office, the entire disclosure of which is hereby incorporated by reference herein.

### BACKGROUND

### Technical Field

This disclosure relates to a sheet loader and an image forming apparatus incorporating the sheet loader.

### Discussion of the Background Art

Various types of sheet loaders are known to include a movable fence member to regulate the position of an end face of a sheet to be loaded on a sheet loader.

### SUMMARY

At least one aspect of this disclosure provides a sheet loader including a housing having a bottom face, and a fence. The fence is movable in a fence moving direction and configured to regulate a position of an end face of a sheet to be loaded in the housing. The fence includes a sliding face and a bend. The sliding face is configured to slide on the bottom face of the housing as the fence moves. The bend is disposed at an end of the sliding face in the fence moving direction and bent in a direction away from the bottom face of the housing.

Further, at least one aspect of this disclosure provides an image forming apparatus including the above-described sheet loader, a sheet feeder, and an image forming device. The sheet feeder is configured to feed the sheet from the sheet loader. The image forming device is configured to form an image on the sheet fed from the sheet feeder.

### BRIEF DESCRIPTION OF THE SEVERAL VIEWS OF THE DRAWINGS

An exemplary embodiment of this disclosure will be described in detail based on the following figured, wherein:

FIG. 1 is a diagram illustrating a schematic configuration of an image forming apparatus according to an embodiment of this disclosure;

FIG. 2 is a perspective view illustrating a sheet tray of the image forming apparatus of FIG. 1;

FIG. 3 is a cross-sectional view illustrating the sheet tray when the sheet tray is stored in the housing of the image forming apparatus;

FIG. 4 is a diagram illustrating the sheet tray when the side of a sheet bundle is regulated by side fences;

FIG. 5 is a perspective view illustrating one of the side fences;

FIG. 6 is a diagram illustrating the sheet tray for explaining an interlocking mechanism of the side fences;

FIG. 7 is a perspective view illustrating one of the side fences with side fence lever;

FIGS. 8A and 8B are cross-sectional views illustrating the sheet tray, viewed along a line of X-X in FIG. 7;

FIG. 9 is an enlarged perspective view illustrating the configuration of a guide on which a metal portion of the side fences slides;

FIGS. 10A and 10B are cross-sectional views illustrating the sheet tray, viewed along a line of Y-Y in FIG. 7;

FIG. 11 is an enlarged view illustrating the sheet tray, viewed from a direction indicated by arrow C in FIG. 10A;

FIG. 12 is an enlarged perspective view illustrating a portion where the metal portion of the side fences slides on the housing of the sheet tray;

FIG. 13 is a diagram illustrating a bending angle α of the sheet tray; and

FIGS. 14A, 14B, and 14C are diagrams illustrating a bending position of the sheet tray.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. Like numbers referred to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Referring now to the drawings, embodiments of the present disclosure are described below. In the drawings for explaining the following embodiments, the same reference codes are allocated to elements (members or components) having the same function or shape and redundant descriptions thereof are omitted below.

In the following description, the term “image forming apparatus” refers to an image forming apparatus that performs image formation by attaching developer or ink to a medium such as paper, OHP sheet, yarn, fiber, cloth, leather, metal, plastic, glass, wood, ceramics and the like. Further, it is to be noted that the term “image formation” indicates an action for providing (i.e., printing) not only an image having meanings such as texts and figures on a recording medium but also an image having no meaning such as patterns on a recording medium. Further, it is to be noted that the term “sheet” is not limited to indicate a paper sheet but also includes OHP transparency sheet, cloth, and a material which is called as a recording target medium, a recording medium, a recording sheet, or a recording paper, and is used to which the developer or ink is attracted. In the above-described embodiment, a sheet material is described as the “sheet”, and the dimensions, the materials, the shapes, the relative arrangements, and the like described for the respective component are examples, and the scope of the present disclosure is not intended to be limited thereto unless otherwise particularly specified. Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

A description is given hereinafter of embodiments where this disclosure is applied to a sheet feed tray that functions as a sheet loader of an electrophotographic image forming apparatus, for example, a copier in the following embodiments. Further, the image forming apparatus 100 is not limited to an electrophotographic image forming apparatus but may be a non-electrophotographic image forming apparatus such as an inkjet type image forming apparatus. Further, the present disclosure is applicable to a bypass sheet feed tray and an original document feeder as well as the sheet feed tray.

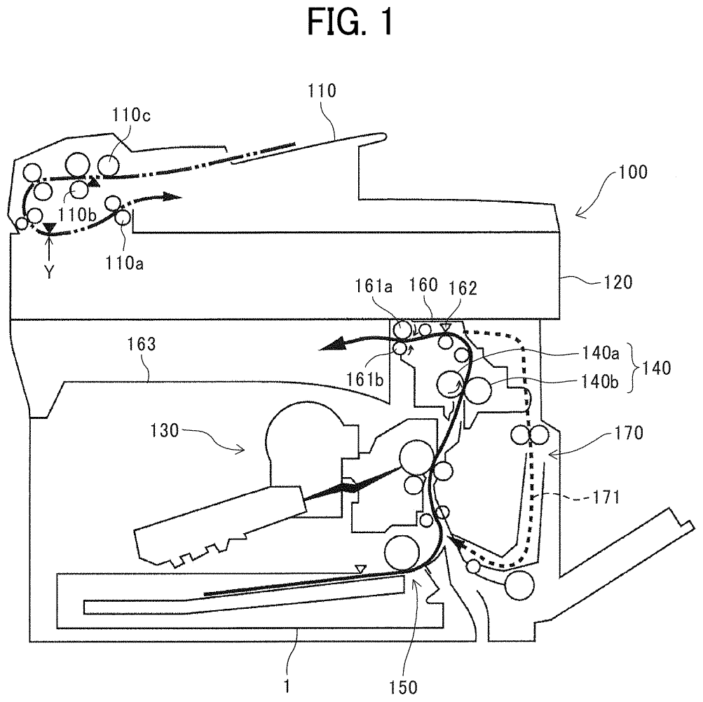

FIG. 1 is a diagram illustrating a schematic configuration of an image forming apparatus 100 according to an embodiment of this disclosure.

As illustrated in FIG. 1, the image forming apparatus 100 includes an automatic document feeder 110, an image reading device 120, an image forming device 130, a fixing device 140, a sheet feeding device 150, a sheet ejecting device 160, and a sheet reentry device 170. These devices form an image forming part.

In this embodiment, the automatic document feeder 110 includes an original document feeding mechanism that performs a sheet-through image reading operation. To be more specific, while image data on an original document is read by an image reader Y while the original document is conveyed by pairs of document conveying rollers 110a, 110b, and 110c. The image reading device 120 employs a known image reading device to read image data of an original document while the original document is being conveyed to the image reading position by the automatic document feeder 110.

The image forming device 130 in the present embodiment employs a known device including a photoconductor, a charger, an optical writing unit, a developing unit, a transfer unit, a cleaning unit, and a charge eliminating unit. In other words, in the image forming device 130, the charger uniformly charges the surface of the photoconductor with electric potential, the optical writing unit forms a latent image on the charged surface of the photoconductor, the developing unit develops the latent image to a visible toner image, and the transfer unit transfers the toner image onto a sheet (recording sheet) . The cleaning unit cleans the surface of the photoconductor by removing residual toner remaining on the surface of the photoconductor. The charge eliminating unit eliminates residual electric potential, that is, resets the value of residual electric potential to zero (0).

The fixing device 140 is provided with a pair of fixing rollers including a heat roller 140a and a pressure roller 140b. The sheet feeding device 150 that functions as a sheet feeder feeds a sheet one by one from a sheet bundle loaded on a sheet tray 1 that functions as a sheet loader and conveys the sheet toward the transfer unit of the image forming device 130. The sheet ejecting device 160 either ejects the sheet traveling from the fixing device 140 to a sheet ejection tray 163 or changes the direction of conveyance of the sheet (switches back the sheet) toward the sheet reentry device 170. Specifically, the sheet ejecting device 160 includes sheet ejection rollers 161a and 161b in pair and a sheet ejection sensor 162. When the sheet ejection sensor 162 detects that the end of the sheet P is nipped or held between the sheet ejection rollers 161a and 161b, the sheet ejection rollers 161a and 161b are reversely rotated to convey the sheet to the sheet reentry device 170.

In the sheet reentry device 170, the sheet having an image formed on one side by the image forming device 130 and being held by the sheet ejection rollers 161a and 161b of the sheet ejecting device 160 passes a switchback passage 171, as indicated by a broken line in FIG. 1, so that the opposite side of the sheet is to face the surface of the photoconductor when another image is transferred onto the sheet. In this state, the sheet passes the switchback passage 171 in the sheet reentry device 170 to be supplied to the image forming device 130. Note that the sheet ejection rollers 161a and 161b in pair are capable of rotating in a forward direction and a reverse direction in response to input by rotations of external gears meshing with each other.

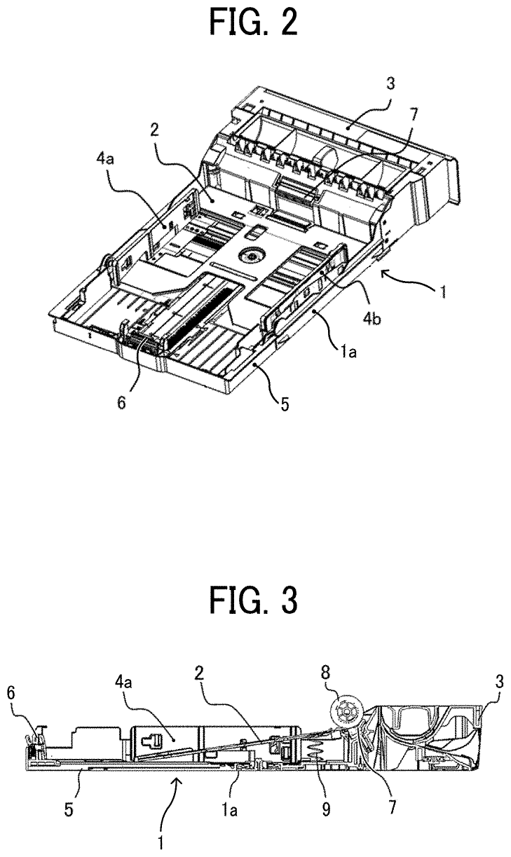

FIG. 2 is a perspective view illustrating the sheet tray 1 of the image forming apparatus 100 of FIG. 1.

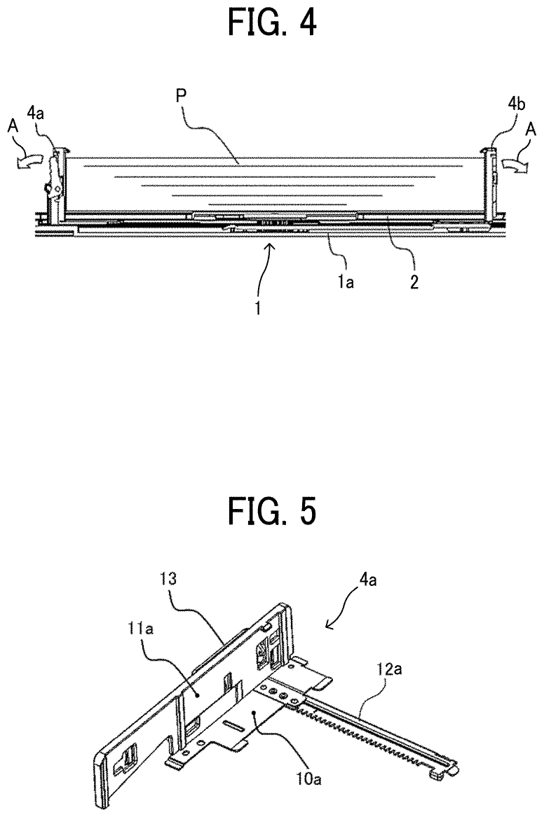

The sheet tray 1 includes an elevator bottom plate 2, side fences 4a and 4b, and a friction pad 7. The elevator bottom plate 2 functions as a loading body capable of lifting and lowering. The side fences 4a and 4b function as a fence or as a pair of side fences movable (in other words, changeable in positions) in the width direction of a sheet (for example, a sheet P in FIG. 4) to regulate the side faces of the sheet and position the width direction of the sheet. These parts are provided in a housing 1a of the sheet tray 1. Further, the sheet tray 1 further includes a rear tray 5 that is stretchable and coupled to the housing 1a at the rear side of the sheet tray 1. The rear tray 5 is provided with an end fence 6 that is movable in the sheet conveyance direction to regulate the trailing end of the sheet. A handle 3 is coupled to at the front side of the sheet tray 1. By grabbing the handle 3, the sheet tray 1 is inserted into and removed from the housing of the image forming apparatus 100.

FIG. 3 is a cross-sectional view illustrating the sheet tray 1 in a state in which the sheet tray 1 is stored in the housing of the image forming apparatus 100.

As the sheet tray 1 is inserted into the housing of the image forming apparatus 100, the elevator bottom plate 2 rotates about a rotary shaft provided to the sheet tray 1 to move upward while being pressed by a sheet feed spring 9. The elevator bottom plate 2 contacts a sheet feed roller 8 that is rotatably supported by the housing of the image forming apparatus 100. As the sheet feed roller 8 is driven to rotate, the sheet loaded on the elevator bottom plate 2 is conveyed. At this time, the side fences 4a and 4b contact the side faces (end faces on either side) of the sheet without a gap to regulate the position of the sheet, thereby preventing skew of the sheet and positional deviation of the sheet in the width direction.

FIG. 4 is a diagram illustrating the sheet tray 1 in a state in which the side faces of the sheet (sheet bundle) are regulated by the side fences 4a and 4b.

The sheet tray 1 employs the side fences 4a and 4b generally made of resin. In a case in which the side fences 4a and 4b are made of resin, the side fences 4a and 4b are deformed when brought into contact with the sheet P as illustrated in FIG. 4. Due to deformation of the side fences 4a and 4b, the interval of the upper side of the side fences 4a and 4b increases in directions indicated by arrow A in FIG. 4, and therefore the precision in position of the sheet P deteriorates. In addition, a user may move and deform the side fences 4a and 4b, preventing smooth movement of the side fences 4a and 4b (resulting in deterioration of smooth movement of the side fences 4a and 4b).

A known sheet feed cassette (sheet feed tray) that functions as a sheet loader includes a side plate and side cursors (fences). The side plate is disposed standing upright to regulate the position of the end face of a sheet. The side cursors are disposed in pair along the horizontal direction and have a horizontal panel extending in the horizontal direction from the lower end of the side plate. The side cursors are movable in directions toward and apart from each other by the equal amount. A part of the horizontal panel of the side cursors is slidably supported on the bottom face of the sheet feed cassette.

The known sheet feed cassette as a sheet loader still left to be improved with respect to the operability in the change of position of the fences (side cursors).

In order to address this inconvenience, the side fences 4a and 4b according to the present embodiment are made of sheet metal (metal plate). The side fences 4a and 4b according to the present embodiment also employ a configuration to eliminate new inconvenience brought by employing sheet metal, as described below.

FIG. 5 is a perspective view illustrating the side fence 4a.

The side fence 4a includes a fence metal portion 10a made of sheet metal. The fence metal portion 10a of the side fence 4a has a shape including an upright portion standing upward in the vertical direction and a horizontal portion extending in the horizontal direction from the lower end of the upright portion. The side fence 4a further includes a side fence cover 11a made of resin. The side fence cover 11a is attached to the fence metal portion 10a of the side fence 4a to cover a side face of the upright portion, the side face facing the sheet or the sheet bundle. Further, the side fence 4a includes a rack 12a made of metal coupled to the horizontal portion of the fence metal portion 10a by caulking. The side fence 4a further includes a side fence lever 13 mounted on an opposite side face of the upright portion of the fence metal portion 10a. The side fence lever 13 is moved by a user to release a locked portion in which the side fences 4a and 4b are locked with respect to the sheet tray 1 (see FIG. 7).

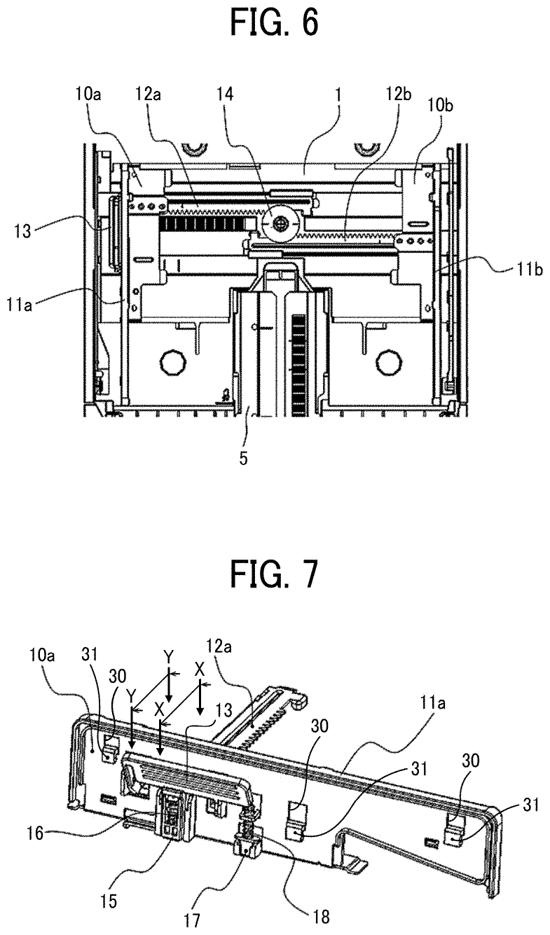

FIG. 6 is a diagram illustrating the sheet tray 1 for explaining an interlocking mechanism of the side fences 4a and 4b. That is, FIG. 6 is a top view of the sheet tray 1 (viewed from above) without the elevator bottom plate 2.

The fence metal portion 10a of the side fence 4a and a fence metal portion 10b of the side fence 4b are disposed substantially symmetric with respect to each other. Similarly, the side fence cover 11a of the side fence 4a and a side fence cover 11b of the side fence 4b are substantially symmetric with respect to each other. As illustrated in FIG. 6, the fence metal portion 10a and the side fence cover 11a of the side fence 4a are disposed on the left side and the fence metal portion 10b and the side fence cover 11b of the side fence 4b are disposed on the right side. As can be seen from FIG. 6, the suffix “a” indicates that the part or component is on the left side and the suffix “b” indicates that the part or component is on the right side. The rack 12a of the side fence 4a on the left side and a rack 2b of the side fence 4b on the right side employ parts having an identical structure.

The fence metal portions 10a and 10b are guided by sliding on the sheet tray 1 to move apart from each other in the horizontal direction (in other words, left and right directions) respectively in FIG. 6. In other words, the fence metal portions 10a and 10b function as sliding faces of the side fences 4a and 4b, respectively, and slide on the housing 1a of the sheet tray 1 in the width direction of the sheet P. A detailed description of the structure in which the fence metal portions 10a and 10b are guided by sliding on the sheet tray 1 is given below. The tooth face of the left rack 12a and the tooth face of the right rack 12b are disposed facing each other and respectively mesh with the teeth of a pinion gear 14. The center of the pinion gear 14 is axially (rotatably) supported by the sheet tray 1 and a screw is fastened to the center of the pinion gear 14 to prevent the pinion gear 14 from coming off while the pinion gear 14 is in a rotatable state.

As the fence metal portion 10a moves, the fence metal portion 10b moves together with the fence metal portion 10a via the pinion gear 14. According to this movement of the fence metal portions 10a and 10b, as one side of the sheet tray 1 on which the side fence lever 13 is mounted (i.e., the side fence 4a) is moved to position the side fence cover 11a to the end face of the sheet (bundle of sheets), the opposite side of the sheet tray 1 (i.e., the side fence 4b) is also moved to position the side fence cover 11b along with movement of the one side of the sheet tray 1.

FIG. 7 is a perspective view illustrating the side fence 4a with the side fence lever 13. To be more specific, FIG. 7 depicts one face of the fence metal portion 10a of the side fence 4a, the face on which the side fence lever 13 is mounted and opposite a face facing the sheet (bundle of sheets).

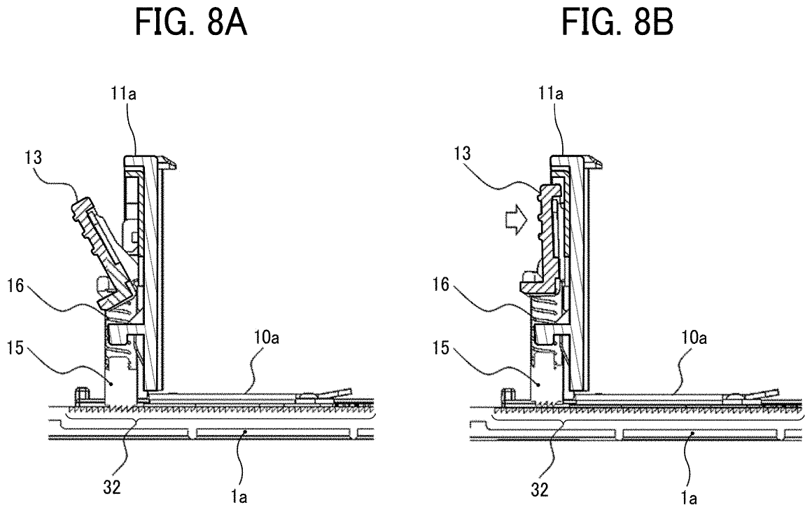

FIGS. 8A and 8B are cross-sectional views illustrating the sheet tray 1, viewed along a line of X-X in FIG. 7. To be more specific, FIG. 8 depicts an interlocking mechanism of the side fences 4a and 4b.

Since the side fences 4a and 4b regulate the position of the sheet corresponding to various sizes, the side fences 4a and 4b are to be locked at any given positions. In FIG. 7, the side fence cover 11a fits into the upright portion of the fence metal portion 10a of the side fence 4a. Specifically, a through hole 30 is formed in the upright portion of the fence metal portion 10a and a fitting claw 31 is integrally provided on the side fence cover 11a. When additionally attaching the side fence cover 11a to the fence metal portion 10a, the fitting claw 31 is hooked at the lower part of the through hole 30.

Further, the side fence cover 11 a integrally has portions to retain the side fence lever 13, a locking claw 15, and a clicking claw 17, so that the side fence lever 13, the locking claw 15, and the clicking claw 17 are exposed on the face opposite the face facing the sheet (bundle of sheets) via respective through holes formed in the upright portion of the fence metal portion 10a. The side fence lever 13 is rotatably supported by the side fence cover 11a. The locking claw 15 is guided to be vertically slidable along the side fence cover 11a and is biased downward by a locking claw spring 16. The clicking claw 17 is guided to be vertically slidable along the side fence cover 11a and is biased downward by a clicking claw spring 18.

FIG. 8A illustrates the sheet tray 1 in a locking state in which the side fences 4a and 4b are locked. FIG. 8B illustrates the sheet tray 1 in an unlocking state in which the side fences 4a and 4b are not released from the locking state.

The lower face of the locking claw 15 has a shape capable of being fastened with a latch, so that the locking claw 15 is latched on the lower face with a latch portion 32 provided on the sheet tray 1. The locking claw 15 has a hook to move in the vertical direction of the side fence cover 11a along with rotation of the side fence lever 13. When the user does not move (rotate) the side fence lever 13, the lower face of the locking claw 15 latches with the latch portion 32 of the sheet tray 1 by the biasing force of the locking claw spring 16, as illustrated in FIG. 8A. With this structure, the side fence 4a does not move in the left side, entering the locking state.

When the user presses the side fence lever 13, the locking claw 15 is lifted as illustrated in FIG. 8B. By so doing, the lower face of the locking claw 15 is separated from the latch portion 32 of the sheet tray 1, and therefore the side fences 4a and 4b are free to move. On the other hand, the clicking claw 17 illustrated in FIG. 7 provides a click feeling, when moving the side fences 4a and 4b, by fitting into a groove provided at the position indicating the regular size of a sheet on the sheet tray 1. By so doing, the user recognizes the position of the regular size of a sheet, thereby preventing slight positional deviation of the side fences 4a and 4b when setting the side fences 4a and 4b.

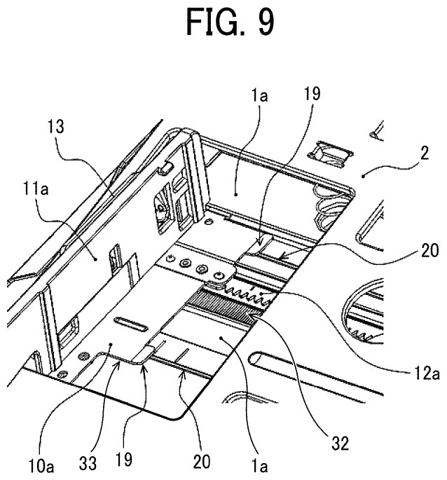

FIG. 9 is an enlarged perspective view illustrating the configuration of a guide on which the fence metal portions 10a and 10b of the side fences 4a and 4b slide.

As described above, since the side fences 4a and 4b are made of sheet metal, new inconvenience has risen as described below. In order to eliminate the inconvenience, in the present embodiment, the fence metal portion 10a that functions as a sliding face of the side fence 4a further includes a bend 19 as a portion of the fence metal portion 10a having a bent surface.

Specifically, the sheet tray 1 has a configuration in which, when moving the side fences 4a and 4b, the lower face of the fence metal portion 10a slides on the bottom face of the housing 1a of the sheet tray 1.

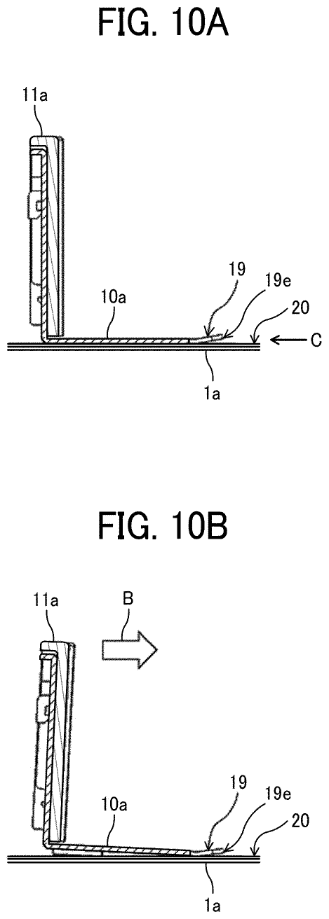

FIGS. 10A and 10B are cross-sectional views illustrating the sheet tray 1, viewed along a line of Y-Y in FIG. 7. Specifically, FIG. 10A is the view for explaining the sheet tray 1 in a state in which the lower face of the fence metal portion 10a slides on the bottom face of the housing 1a of the sheet tray 1. FIG. 10B is the view for explaining the sheet tray 1 in which the lower face of the fence metal portion 10a is sliding on the bottom face of the housing 1a of the sheet tray 1 in a direction indicated by arrow B.

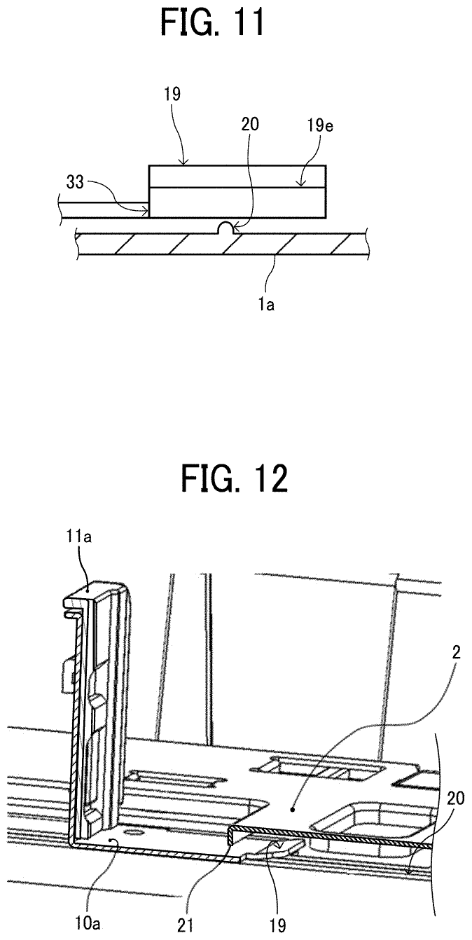

FIG. 11 is an enlarged view illustrating the sheet tray 1, viewed from a direction indicated by arrow C in FIG. 10A.

The fence metal portion 10a is slidably guided by the bottom face of the housing 1a of the sheet tray 1. However, the fence metal portion 10a does not move smoothly on the bottom face of the housing 1a of the sheet tray 1 without a certain amount of play in the vertical direction. Due to the structure with a play, the fence metal portion 10a is slightly tilted toward a fence moving direction in which the side fence 4a (as well as the side fence 4b) moves, as illustrated in FIG. 10B. The fence moving direction corresponds to the width direction of the sheet P. Further, since a user may touch the fence metal portion 10a, an appropriate pulling direction is set to prevent burr from a pressing process on the upper face of the fence metal portion 10a, which causes burr on the lower face of the fence metal portion 10a. Consequently, the lower face edge (for example, a lower face edge 19e) of the fence metal portion 10a scrapes a fence sliding area on the bottom face of the housing 1a of the sheet tray 1 when moving the side fence 4a, resulting in deterioration of the operability (movement) of the side fence 4a and generation of scratches or damages to the fence sliding area on the bottom face of the housing 1a of the sheet tray 1. In particular, when a fence sliding area is made of resin material, the bottom face having the resin fence sliding area is scraped easily. The bottom face of the housing 1a of the sheet tray 1 is made of resin. Therefore, the fence sliding area of the housing 1a of the sheet tray 1 is scraped easily.

In order to address this inconvenience, the fence metal portion 10a of the present embodiment includes bends 19, as illustrated in FIG. 9. Specifically, the fence metal portion 10a includes one bend 19 on the front side and another bend 19 on the rear side in a tray moving direction in which the sheet tray 1 is inserted into or removed from the housing of the image forming apparatus 100. Each of the bends 19 is disposed at a sheet center side end of the lower face of the fence metal portion 10a in the tray moving direction, in other words, in the width direction of the sheet P, and bent in a direction away from the bottom face of the housing 1a of the sheet tray 1. Note that the bends 19 are referred to in a singular form, for convenience.

A rib 20 is a fence sliding area (sliding target portion) formed on the bottom face of the housing 1a of the sheet tray 1, on the longitudinal sides, that is, the front side and the rear side, as to face each bend 19. According to this structure, the fence metal portion 10a is capable of separating the lower face edge 19e on the leading end of the bend 19 from the rib 20 of the housing 1a of the sheet tray 1, as illustrated in FIG. 10A, thereby preventing contact of the lower face edge 19e of the bend 19 to the fence sliding area on the bottom face of the housing 1a of the sheet tray 1 when the side fence 4a is moved. Further, even when the side fence 4a inclines when moved, as illustrated in FIG. 10B, as long as the height (clearance) of bending of the bend 19 from the fence sliding area on the bottom face of the housing 1a of the sheet tray 1 is set properly, the lower face edge 19e on the leading end of the bend 19 is prevented from contacting the rib 20. In addition, as illustrated in FIG. 11, the width of the fence sliding area on the bottom face including the rib 20 is sufficiently narrower (smaller) than the width of the bend 19 of the fence metal portion 10a of the side fence 4a and the positional relation of the bend 19 and the rib 20 is set such that the rib 20 is positioned within the width of the bend 19. Therefore, the fence metal portion 10a of the side fence 4a contacts the rib 20 having the width smaller than the width of the bend 19. Accordingly, this structure prevents an edge 33 (see FIGS. 9 and 11) of the fence metal portion 10a orthogonal to the fence sliding area (rib 20), from contacting the rib 20 and thus impairing the operability (movement) of the side fence 4a.

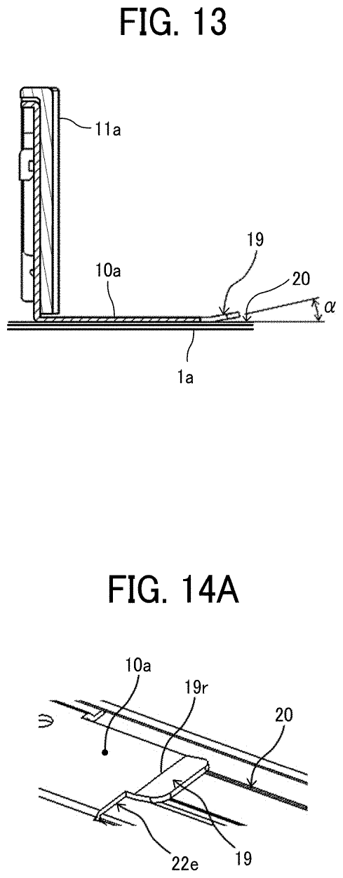

FIG. 12 is an enlarged perspective view illustrating a portion where the lower face of the fence metal portion 10a slides on the bottom face of the housing 1a of the sheet tray 1. FIG. 13 is a diagram illustrating a bending angle α of the sheet tray 1.

The sliding portion of the fence metal portion 10a is located lower than the elevator bottom plate 2. Therefore, when a small size sheet is set in the sheet tray 1, the bend(s) 19 of the fence metal portion 10a may slide under the elevator bottom plate 2, as illustrated in FIG. 12. Since the elevator bottom plate 2 may need to have strength to endure the weight of sheets loaded on the sheet tray 1, a flange 21 is provided on the outer periphery of the elevator bottom plate 2 for reinforcement of the strength of the elevator bottom plate 2. In order to slide under the elevator bottom plate 2 without contacting the flange 21, the height of the bend 19 may be set smaller (lower) than the height of the flange 21. If the bending angle of the bend 19 is a right angle (that is, 90 degrees), the length of the bend 19 is not sufficient for processing, and therefore the pressing process may not be performed. From this point of view, a bending angle α illustrated in FIG. 13 (in other words, an angle of the bent surface of the bend 19 of the fence metal portion 10a of the side fence 4a and the bottom face of the housing 1a of the sheet tray 1) is preferably set to an acute angle less than 90 degrees. According to this structure, the workability is enhanced, thereby achieving space saving in the direction of height (vertical direction) of the bend 19.

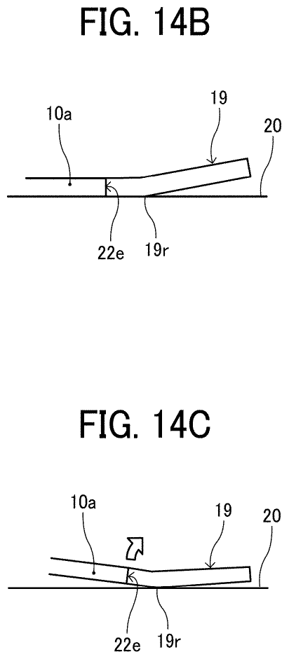

FIGS. 14A, 14B, and 14C are diagrams illustrating a bending position of the sheet tray 1.

An end face edge 22e illustrated in FIG. 14A is one of edges of the fence metal portion 10a other than the bend 19 (the lower face edge 19e). Similar to the lower face edge 19e of the bend 19, when the side fences 4a and 4b are inclined when moving in the fence moving direction, the end face edge 22e is also likely to contact the fence sliding area (rib 20) on the bottom face of the housing 1a of the sheet tray 1. In order to address this inconvenience, the end face edge 22e that is disposed extending in a direction orthogonal to the fence moving direction of the side fence 4a, except for the bend 19, is retracted to a recess provided at a position apart from a bending point 19r (that is, the position is not close to the sheet center side but is close to the upright portion side). With this structure, as illustrated in FIGS. 14B and 14C, the end face edge 22e of the fence metal portion 10a is avoidable from contacting the fence sliding area on the bottom face of the housing 1a of the sheet tray 1.

Note that the end face edge 22e that is disposed extending in a direction orthogonal to the fence moving direction other than the bend 19 is generated in the following case. That is, the end face edge 22e may be generated when the fence metal portion 10a has an opposite area facing the bottom face of the housing 1a of the sheet tray 1 over a given range in the width direction that is a direction orthogonal to the fence moving direction of the fence metal portion 10a, and the bend 19 (to be more specific, the surface of the bend 19) is bent from a part in the width direction of the opposite area toward the sheet center side in the sheet tray 1. In this case, the position of “the end face edge 22e that is disposed extending in a direction orthogonal to the fence moving direction other than the bend 19” is a projection root position of the bend 19. Therefore, “the end face edge 22e is retracted to the recess provided apart from the bending point 19r (that is, the position is not close to the sheet center side but is close to the upright portion side)” is replaced that the bent surface of the bend 19 starts bending from the bending point 19r that is closer to the sheet center side than the projection root position (the end fence edge 22e).

FIG. 14C is a diagram illustrating the fence metal portion 10a being inclined when moving in the fence moving direction, which similar to FIG. 10B. As illustrated in FIG. 14B, the end face edge 22e is located on the left side in FIG. 14B from the bending point 19r (that is, the position is not close to the sheet center side but is close to the upright portion side), where the end face edge 22e is retracted to the right side in FIG. 14B, which is the fence moving direction. According to this structure, as illustrated in FIG. 14C, even when the side fence 4a is inclined in the fence moving direction, the end face edge 22e moves upward about the bending point 19r in a direction away from the end face edge 22e from the rib 20. Therefore, an increase in movement of the side fence and scraping the fence sliding area on the bottom face of the housing 1a of the sheet tray 1.

What has been described above is an example, and various modifications may be made, and this disclosure is applicable to other various apparatuses and devices. For example, the above-described examples have aspects in which the fence material is metal and the fence sliding area of a target member is made of resin, so that the fence made of metal easily scrapes the fence sliding area of the target member, and therefore a problem is most likely to occur easily. However, the configuration of the fence member is not limited to the above-described examples. For example, this disclosure may be applied when the hardness of the fence and the hardness of the target member are in an opposite relation (in other words, the fence is made of resin and the target member is made of metal) or when the hardness of the fence and the hardness of the target member are equal (in other words, the fence and the target member are made of materials having equal or similar hardness) . In either case, deterioration in the operability of a sheet tray (such as movement of a side fence or side fences) due to contact of the edge portion of the fence with the housing of the sheet tray.

In addition, the above-described examples describe that the edge portion having burr of a sheet metal scrapes the fence sliding area of the target member. However, this disclosure may also be effective to avoid (eliminate) the inconvenience in which an irregular shape portion generated at a parting line of a resin molding product scrapes the fence sliding area of the target member.

The effects described in the embodiments of this disclosure are listed as most preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of the invention, and are included in the scope of the invention recited in the claims and its equivalent.

Any one of the above-described operations may be performed in various other ways, for example, in an order different from the one described above.

What is claimed is:

1. A sheet loader comprising:
a housing having a bottom face; and
a fence movable in a fence moving direction and configured to regulate a position of an end face of a sheet to be loaded in the housing,
the fence including
a sliding face configured to slide on the bottom face of the housing as the fence moves; and
a bend disposed at an end of the sliding face in the fence moving direction and bent in a direction away from the bottom face of the housing.

2. The sheet loader according to claim 1, further comprising a loading body disposed above the bottom face of the housing and configured to load the sheet,
wherein the sliding face of the fence is located between the loading body and the bottom face, and
wherein an angle of a bent surface of the bend and the bottom face of the housing is an angle less than 90 degrees.

3. The sheet loader according to claim 1, further comprising a sliding target portion on the bottom face of the housing,
wherein the sliding face of the fence is configured to contact the sliding target portion having a width in a direction orthogonal to the fence moving direction, smaller than a width of the sliding face in the direction orthogonal to the fence moving direction.

4. The sheet loader according to claim 1,
wherein the fence has an opposite area facing the bottom face of the housing over a range in an orthogonal direction to the fence moving direction,
wherein a bent surface of the bend projects from a part of the opposite area in the orthogonal direction of the opposite area toward a center of the sheet in a width direction of the sheet, and
wherein the bend starts bending from a position that is closer to the center of the sheet in the width direction of the sheet than a projection root position.

5. The sheet loader according to claim 1,
wherein the fence is made of metal.

6. The sheet loader according to claim 5,
wherein the bottom face is made of resin.

7. The sheet loader according to claim 1,
wherein the fence includes a pair of side fences configured to regulate the position of the end face of the sheet at both ends in a width direction of the sheet.

8. An image forming apparatus comprising:
the sheet loader according to claim 1;
a sheet feeder configured to feed the sheet from the sheet loader; and
an image forming device configured to form an image on the sheet fed from the sheet feeder.
